(19) United States
(12) Patent Application Publication
(10) Pub. No.: US 2006/0129946 A1
(43) Pub. Date: Jun. 15, 2006

(54) Seamless activation of a GUI window in a computing environment

(75) Inventor: Lee Zachary Hasiuk, Rochester, NY (US)

Correspondence Address: F. JASON FAR-HADIAN;CENTURY IP GROUP, PO BOX 7333, NEWPORT BEACH, CA, 92658-7333, US

(73) Assignee: Idealab, Inc.

(21) Appl. No.: 11/297,875

(22) Filed: Dec. 8, 2005

Related U.S. Application Data
(60) Provisional application No. 60/636,815, filed on Dec. 15, 2004.

(51) Int. Cl. G06F 17/00

(52) U.S. Cl. 715/779

(57) ABSTRACT

A method in a computing system with a graphical user interface (GUI) for installing a desk band is provided. The computing system comprises an operating system and a shell. An installation program is used to instantiate a desk band activator object within the context of the shell. The desk band activator object is configured to obtain a pointer to a desk band object and, in the context of the shell, pass that pointer to a method of an interface. The method in turn is used to activate the desk band object.

### CROSS-REFERENCE TO RELATED APPLICATIONS

Pursuant to 35 U.S.C. § 119(e)(1), this application claims the benefit of earlier filing date and right of priority to Provisional Application No. 60/636,815, filed on Dec. 15, 2004, entitled “A Method for Programmatically Installing a Desk Band” the content of which is hereby incorporated by reference herein in its entirety.

### COPYRIGHT & TRADEMARK NOTICE

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or limit the scope of this invention to material exclusively associated with such marks.

### FIELD OF THE INVENTION

The invention relates generally to installation of desk band objects in a computing environment, and more particularly to the automatic activation of a toolbar in a graphical user interface of a computing system.

### BACKGROUND

A graphical user interface (GUI) is a visual interactive tool that allows a human user to control input and output of data in a computing system, such as a personal computer. A GUI typically provides the windows, menus and methods of interaction between a user and the computing environment. Referring to FIG. 1A, a typical GUI environment is illustrated, wherein a plurality of objects on a desktop 100 may be selected by way of a pointer 106.

As shown, GUI objects may be displayed as windows, icons (e.g., notepad, recycle bin, etc.), or band objects (e.g., taskbar 110, desk band 120, a tool bar, etc.). The functionality and operation of all objects including band objects are generally controllable within the computing system's operating environment, and particularly by the operating system.

In the Microsoft Windows™ operating system, band objects can be implemented as horizontal or vertical windows or toolbars. Band objects are contained by either an application (e.g., Internet Explorer™) or the operating system's shell, where they are referred to as desk bands. The shell typically provides a mechanism whereby users can manipulate files, applications and other objects.

In certain versions of Microsoft Windows, custom objects can be used to create special GUI objects such as tool bands and desk bands. A tool band is a desk band object that is used to implement and display a toolbar within another window. For example, a tool band in an Internet Explorer window can be activated from a Toolbars submenu of the View menu. Desk bands, in contrast to tool bands, are used to implement a window directly on the desktop.

Referring to FIG. 1B, for example, a user can utilize a pointer 154 to right-click on a taskbar 110 to pull-up a menu 140 having Toolbars menu item 142. Left-clicking on Toolbars menu item 142 results in the display of a submenu 150 having a Sample Desk Band menu item 152. Left-clicking on the Sample Desk Band menu item 152 can, for example, activate a desk band 120 on the taskbar 110.

The above-described process can be also used to create a toolbar, which is a type of desk band. Accordingly, the conventional method for activating a desk band or a toolbar requires all the above steps to be performed by a user. Unfortunately, these activation steps are not well known by many users and burdensome to implement by both casual users and sophisticated users alike. Thus, many developers of third party software that deploy toolbars as a part of their products and services are forced to provide detailed user instructions on how to install and activate a toolbar.

To overcome the above inconvenient approach, some installation programs automatically feed keyboard input and mouse clicks or other forms of graphical pointer input to the shell, in effect ‘simulating’ user interaction with the keyboard and graphic menus to activate a toolbar as discussed above. Such simulation methods are, however, very difficult to implement and often require “screen scraping” that involves detailed calculations to identify the text and coordinates of the graphic object displayed on the screen to determine the requisite pointer locations, clicks, and other related GUI input data.

Unfortunately, the above methods are highly reliant on the specific location and coordinates of graphic menus and objects in the GUI environment. Therefore, when a new version of the operating system with new graphics is released, the particular toolbar activation method implemented for the older versions of the system fails to function properly.

For the above reasons, the current methods for installing and activating desk band objects are unreliable and burdensome to the users and the providers. Therefore, a more convenient solution is needed that can resolve the above-mentioned problems.

### BRIEF DESCRIPTION OF DRAWINGS

The accompanying drawings are included to provide a further understanding of the invention and are incorporated in and constitute a part of this specification. The drawings illustrate exemplary embodiments of the invention and together with the description serve to explain the main principles.

FIG. 1A illustrates a typical graphical user interface (GUI) with multiple GUI objects.

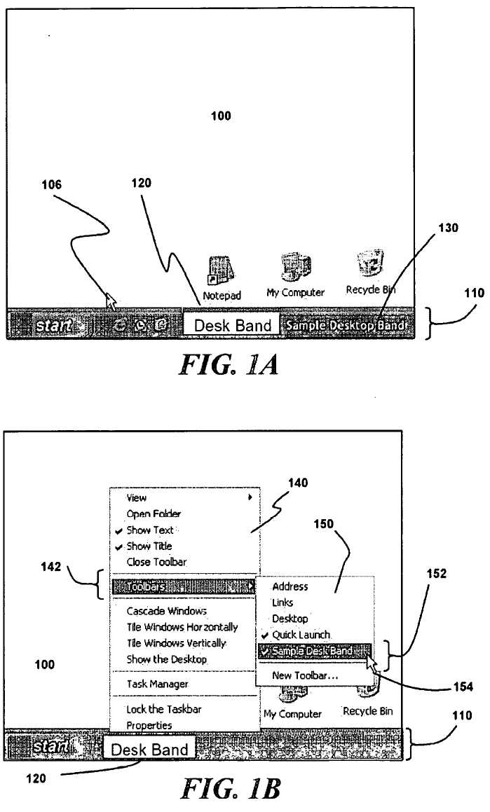

FIG. 1B illustrates an exemplary method for activating a desk band from the taskbar.

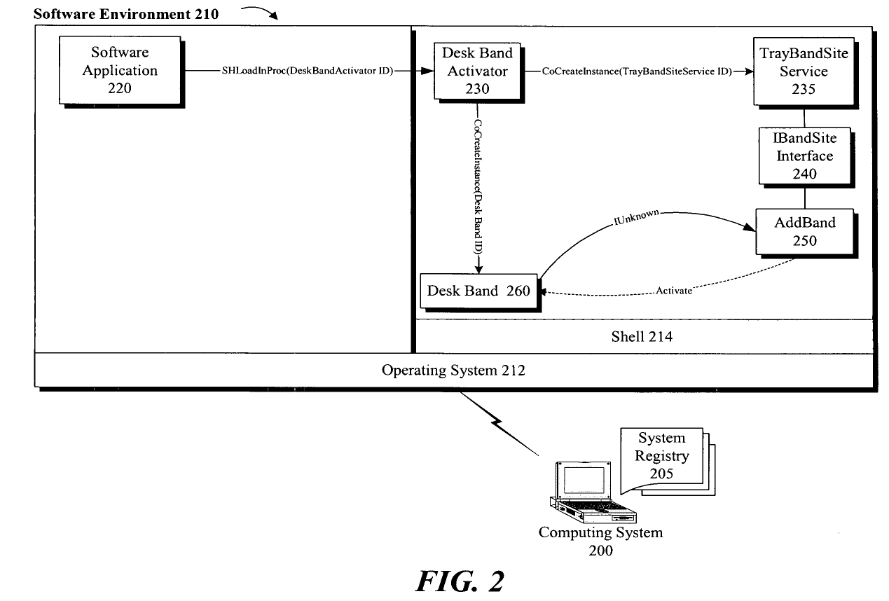

FIG. 2 illustrates an exemplary software environment for activation of a desk band, in accordance with one aspect of the invention.

FIGS. 3 and 4 illustrate flow diagrams of preferred steps of one or more methods for invoking a desk band, in accordance with one or more embodiments.

FIG. 5 illustrates a method for obtaining a reference to an object used to activate a desk band, in accordance with one aspect of the invention.

Features, elements, and aspects of the invention that are referenced by the same numerals in different figures represent the same, equivalent, or similar features, elements, or aspects in accordance with one or more embodiments of the system.

### SUMMARY

In accordance with one aspect of the invention, a method in a computing system with a graphical user interface (GUI) for installing a desk band is provided. The computing system comprises an operating system and a shell. An installation program is used to instantiate a desk band activator object within the context of the shell. The desk band activator object is configured to obtain a pointer to a desk band object and, in the context of the shell, pass that pointer to an interface for a method. The method in turn is used to activate the desk band object.

In a preferred embodiment, the method comprises instantiating a first object within context of the shell; instantiating the desk band object using the first object, wherein a second pointer identifying the desk band object is returned; instantiating a second object providing a first interface to a first method for controlling the desk band object; and passing the second pointer to the first method for controlling the desk band object.

In accordance with another embodiment, the method for installing the desk band comprises registering a first identifier in a database accessible by the shell, wherein the first identifier is associated with a desk band activator object; loading the desk band activator object within context of the shell by passing the first identifier to a loading function.

The method, in a preferred embodiment, further comprises instantiating the desk band activator object having a class identifier associated with an application programming interface (API) adapted to control a desk band object; instantiating a desk band object using a constructor of the desk band activator object, wherein a second pointer identifying the desk band object is returned; instantiating a second object providing a first interface to a first method for controlling the desk band object; and passing the second pointer to the first method for controlling the desk band object.

In one embodiment, the method may also comprise controlling the desk band object referenced by the second pointer, using the first method, wherein the controlling comprises activating the desk band object. The second object is instantiated using the constructor of the desk band activator object. The second pointer is returned by obtaining an IUnknown interface pointer of the desk band object using a class identifier of the desk band object; and obtaining the second pointer using the IUnknown interface pointer. The first interface to the first method is provided by obtaining an IUnknown interface pointer of the second object; and obtaining a pointer to the first interface by querying the IUnknown interface of the second object.

In accordance with another embodiment, a method of activating a desk band comprises loading a program code for instantiating a first object configured to activate a desk band; instantiating the first object, wherein a constructor of the first object is executed within the shell's context; instantiating a desk band, using the constructor, if a desk band instance does not exist within context of the shell; instantiating a second object using the constructor, wherein the second object has a first interface to a first method configured for activating the desk band; obtaining a desk band interface pointer associated with the desk band running in the context of the shell; and passing the desk band interface pointer to the first method.

The desk band interface pointer may be used to activate the desk band. In an exemplary embodiment, the desk band interface is an IUnknown interface pointer of the desk band. The first interface to the first method may be obtained by obtaining an IUnknown interface pointer of the second object using a class identifier of the second object; and querying the IUnknown interface of the second object to obtain a pointer to the first interface.

In a preferred embodiment, the loading is performed by way of an external program calling SHLoadInProc application program interface (API) and passing to it an identifier associated with the first object. The constructor instantiates the second object as an instance of a TrayBandSiteService class. The TrayBandSiteService provides a pointer to the first interface.

In accordance with yet another embodiment, a computer readable code having computer executable instructions for installing a desk band in a computing system having an operating system and a shell with a graphical user interface (GUI), wherein the computer readable code is external to the shell.

The computer readable code comprises logic code for loading a program code for instantiating a first object configured to activate a desk band; logic code for instantiating the first object, wherein a constructor of the first object is executed within the shell's context; logic code for instantiating a desk band, using the constructor, if a desk band instance does not exist within context of the shell; logic code for instantiating a second object using the constructor, wherein the second object has a first interface to a first method configured for activating the desk band; logic code for obtaining a desk band interface pointer associated with the desk band running in the context of the shell; and logic code for passing the desk band interface pointer to the first method.

These and other embodiments of the present invention will also become readily apparent to those skilled in the art from the following detailed description of the embodiments having reference to the attached figures, the invention not being limited to any particular embodiments disclosed.

### DETAILED DESCRIPTION OF THE PREFERRED EMBODIMENTS

In accordance with one or more aspects of the invention, systems and methods for the automatic and reliable installation and activation of a desk band object or toolbar are provided.

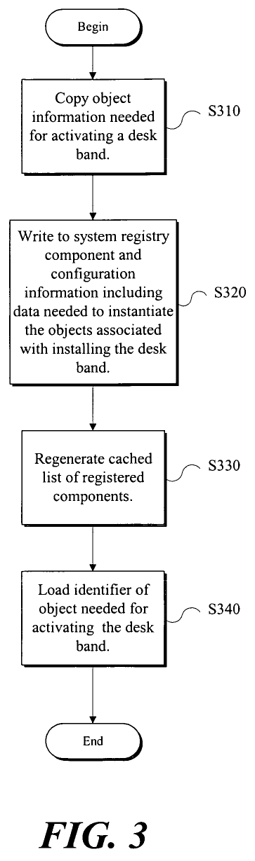

Referring to FIG. 2, a computing system 200 is presented having a software environment 210 executed over a hardware infrastructure (not shown). The software environment 210 comprises an operating system 212 and a shell 214. Operating system 212 is a master program that is loaded to control the software environment 210 with respect to program execution, data structures, device interface, security and GUI functions.

Shell 214 defines the interfaces for the outer layer of operating system 212. Shell 214 has a defined address space (i.e., heap) and threading model (i.e., process management scheme) that are independent from other programs and software applications which are executed on top of operating system 212 and external to shell 214.

The noted independent address space (i.e., memory area reserved for the shell) ensures the shell's secure and reliable operation. As such, certain software applications (e.g., installation software, word processing software, etc.) that run on top of operating system 212 are external to shell 214's address space and cannot interfere with the operation of the shell or the operating system.

In accordance with one aspect of the invention, a software application 220 runs external to shell's 214 address space (i.e., outside the shell context) and is configured to install or activate a desk band or a toolbar on a GUI environment of computing system 200. Software application 220 may be an installation program, for example, or other program implemented to add a desk band within the context of shell 214.

In order for software application 220 to successfully install or activate a tool bar, a desk band object is preferably instantiated within the context of shell 214, so that the related processes and objects can be managed by shell 214 after software application 220 completes execution and exits. Otherwise, if the tool bar is instantiated outside the context of shell 214, once software application 220 exits, the toolbar may disappear unexpectedly or the taskbar environment may become corrupt due to the violation of the taskbar's threading model.

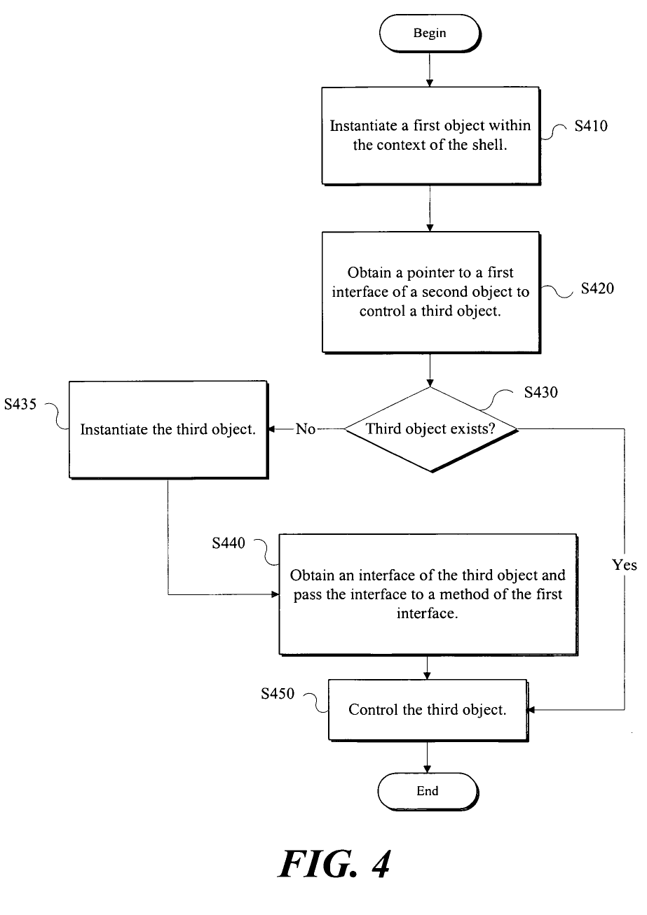

Referring to FIGS. 2 and 3, in one embodiment, when software application 220 is executed, information such as software code and related data needed for installing or activating a desk band are copied to computing system's 200 hard drive (S310). In other embodiments, the needed information may be previously stored on the hard drive or stored on a storage unit remote to computing system 200.

In an exemplary embodiment, the copied information comprises one or more dynamic link libraries (DLLs) defining Component Object Model (COM) objects and other configuration information that may be used to install or activate or facilitate the installation and/or activation of the toolbar. COM is a component software architecture from Microsoft, which defines a structure for building program routines (i.e., objects) that can be instantiated and executed in a Windows environment. COM provides a way to define an object interface independent from a programming language.

In the following, an exemplary embodiment of the invention is described as applicable to the software architecture associated with the Microsoft Windows operating system. This description is, however, by way of example. Thus, it is noteworthy that alternative embodiments may be implemented in association with other operating systems, environments and architectures, without detracting from the scope of the invention.

Referring back to FIGS. 2 and 3, software application 220 is configured to write component and configuration information, including data and pointers needed to instantiate the COM objects for the toolbar, to a system registry 205 (S320). System registry 205 is preferably a system-defined database used to store and retrieve configuration and component information for objects that are to be created or instantiated during the execution of the applications.

In certain embodiments, software application 220 causes shell 214 to regenerate the cached list of registered components i.e., toolbars (S330). Preferably, in the Windows operating system, this process is preformed by deleting, for example, one or more Windows registry keys. It should be noted that depending on implementation regenerating the cached list is optional.

Referring again to FIGS. 2 and 3, software application 220 is configured to call a loading function such as an application programming interface (API) to load the identifier of a first object needed for activating the desk band within the context of the shell (S340). This API comprises a set of routines, protocols, and tools for use by software application 220 and includes the building blocks needed for providing a service that activates and manages the toolbar.

In a preferred embodiment, the API called by software application 220 is SHLoadInProc( ), for example. It is noteworthy, however, that in alternative embodiments, instead of calling SHLoadInProc( ), other loading functions such as SetWindowsHookEx( ) or CreateRemoteThread( ) may be called to create, respectively, a global hook or a remote thread to instantiate the first object within the context of the shell to activate the desk band.

SHLoadInProc( ) is an API configured to load a first DLL referenced in system registry 205, wherein the DLL contains a first object—hereafter referred to as desk band activator 230 by way of example—such that the first object can be instantiated within the context of shell 214.

To accomplish this, software application 220 passes to SHLoadInProc( ) a unique identifier also referred to as a class identifier (e.g., CLSID_DeskbandActivator) that specifically identifies the desk band activator 230. Based on this unique identifier, preferably stored in system registry 205, SHLoadInProc( ) loads the related DLL and configuration information for desk band activator 230.

In a preferred embodiment, the unique identifier (e.g., CLSID_DeskbandActivator) is a 128-bit globally unique number, for example, that can be used to identify and load the desk band activator 230. This 128-bit number, in one embodiment, is the universally unique identifier (UUID) for a desk band COM object.

According to one embodiment, the following program code represents an exemplary method that may be implemented as logic code embedded in a computer readable medium to cause a processor to load the desk band activator 230:
if (SHLoadInProc(_uuidof(SampleActivator))==NOERROR)

Referring to FIGS. 2 and 4, after the needed information is loaded, desk band activator 230 is instantiated within the context of shell 214 and its constructor is called (S410). Since an instance of desk band activator 230 is created within the context of shell 230, the constructor of desk band activator 230 will run within the context of the shell, as well.

The constructor is a function which is called automatically when an instance of the desk band activator 230 is created and is used to initialize the data members of the object to a default state, for example. The constructor in one embodiment is also used to allocate the related resources (e.g., memory, files, etc.).

It should be noted that the use of a constructor to perform certain operations, such as introducing code for execution in the context of the shell, is provided by way of example. Other methods (e.g., AddRef( ) or QueryInterface( )) may be called to instantiate objects within the context of the shell or to produce the same results discussed here in association with the constructor.

In a preferred embodiment, the constructor of the desk band activator 230 obtains a pointer to a first interface of a second object to control a third object (S420). Hereafter, we refer to the second object as the TrayBandSiteService 235 by way of example. The TrayBandSiteService 235 is an object that can be accessed by way of its unique identifier, as provided in more detail below, to provide an interface pointer to a method that can be used to activate a desk band 260.

Hereafter, we refer to the first interface pointer of TrayBandSiteService 235 as IBandSite interface 240, by way of example. The IBandSite interface 240 provides methods to activate, enumerate, make visible/invisible, add or remove desk band objects. The IBandSite interface is used to call a method—hereafter AddBand 250 by way of example—to activate desk band 260, in accordance with one or more embodiments.

To accomplish the above process, the constructor of the desk band activator 230 calls a function (e.g., CoCreateInstance) with the unique identifier of the TrayBandSiteService API (e.g., CLSID_TrayBandSiteService). This unique identifier, in a preferred embodiment, is a 128-bit globally unique identifier (i.e., F60AD0A0-E5E1-45CB-B51A-E15B9F8B2934) defined in a Windows API file (e.g., ShObjIdl.h). By passing the interface identifier of the IBandSite interface 240 to the CoCreateInstance call, a pointer to the IBandSite interface of the CLSID_TrayBandSiteService object is returned.

The CoCreateInstance function creates an object of the type specified by the class identifier. Accordingly, constructor of desk band activator 230 obtains the interface pointer of the TrayBandSiteService 235 (i.e., IBandSite interface 240) within the context of the shell by using the TrayBandSiteService.

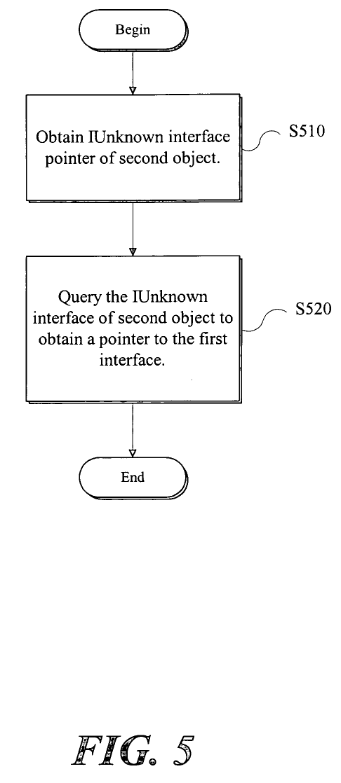

Referring to FIGS. 2 and 5, in an alternative embodiment, an IUnknown interface pointer of TrayBandSiteService 235 is obtain via CLSID_TrayBandSiteService (S510). The IUnknown interface is the basis of all Component Object Model (COM) interfaces. This interface contains a set of methods that control the lifetime of the object, and provides a means of querying for the interfaces implemented by the object.

Thus, IBandSite interface 240 is obtained by querying the IUnknown interface 240 of TrayBandSiteService 235, using IUnknown's QueryInterface method, for example. In a preferred embodiment, the interface identifier of the IBandSite interface is a 128-bit unique value (i.e., 4CF504B0-DE96-11D0-8B3F-00A0C911E8E5), and is stored in the constant IID_IBandSite in ShObjIdl.h, for example.

According to one embodiment, the following program code represents one or more alternative methods that may be implemented as logic code embedded in a computer readable medium to provide a pointer to the IBandSite interface 240 of the TrayBandSiteService 235:

IUnknown* pBandSiteUnknown;
if (SUCCEEDED(CoCreateInstance(CLSID_TrayBandSiteService, NULL,

CLSCTX_INPROC_SERVER,

IID_IUnknown, (void**)&pBandSiteUnknown))) {

IBandSite* pBandSite;
if (SUCCEEDED(pBandSiteUnknown−>QueryInterface(IID_IBandSite,

(void**)&pBandSite))) {

pBandSite−>Release( );

}
pBandSiteUnknown−>Release( );

}

Referring back to FIGS. 2 and 4, in one or more embodiments, the constructor of desk band activator 230 can use the IBandSite interface 240 to call one of its methods (hereafter referred to as the AddBand method 250 by way of example) to activate or instantiate a desk band 260.

In some embodiments, the constructor of desk band activator 230 determines whether a desk band 260 already exists (S430). If not, then an instance of desk band 260 is created by the constructor by calling a function (e.g., CoCreateInstance) with an identifier of desk band 260 registered in system registry 205 (S435). Then, an interface pointer (e.g., IUnknown interface) of desk band 260 is obtained from the CoCreateInstance function and is passed to AddBand method 250 of the IBandSite interface 240 (S440).

This provides to the AddBand method 250 the interface pointer (e.g., IUnknown interface) of desk band 260. AddBand method 250 having the interface pointer of desk band 260 can add the desk band 260 to the list of active desk bands, and the IBandSite interface 240 can be used to control, activate, enumerate, make visible/invisible, add or remove desk band 260, in accordance with one or more embodiments (S450).

In accordance with one aspect of the system, the following program code represents one or more exemplary methods that may be implemented as logic code embedded in a computer readable medium to instantiate and/or activate toolbar object 260:

CComPtr<IBandSite> pBandSite;
if (SUCCEEDED(pBandSite.CoCreateInstance(CLSID_TrayBandSiteService))) {

// Create an instance of our desk band.

CComPtr<IDeskBand> pBand;
if (SUCCEEDED(pBand.CoCreateInstance(CLSID_SampleBand)))

// Pass it to the IBandSite object so it can be added
// to the taskbar and made visible.
pBandSite−>AddBand(pBand.Detach( ));

Accordingly, the above sets of codes represent exemplary program code for implementing executable object modules that can be called to install a tool bar in a GUI environment. The following code exemplifies the content (e.g., COM objects and installation programs) that may be copied to a recording medium in executable form as software application 220 or its components to enable computing system 200 to call the above-described object modules.

The methods and processes disclosed herein have been described by way of example as code written in specific programming languages. It should be noted, however, that the above exemplary code is not to limit the scope of the invention to the particular code and programming language included here. Rather, the exemplary embodiments are provided to attempt to disclose the best mode for practicing the invention as known to the applicant.

Further, the words used in this specification to describe the invention and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The invention is not limited to the exemplary embodiments, but may have applicability to more than one operating system and computing environment. Thus, it should be understood that the invention is not limited by the foregoing descriptions of the preferred embodiments, but embraces all alternatives, modifications, and variations in accordance with the spirit and scope of the appended claims and their full scope of equivalents.

What is claimed is:

1. A method in a computing system with a graphical user interface (GUI) for installing a desk band, the computing system comprising an operating system and a shell, the method comprising:
instantiating a first object within context of the shell;
instantiating the desk band object using the first object, wherein a second pointer identifying the desk band object is returned;
instantiating a second object providing a first interface to a first method for controlling the desk band object; and
passing the second pointer to the first method for controlling the desk band object.

2. The method of claim 1, further comprising:
loading the first object within the context of the shell by passing a first identifier associated with the first object to a loading function.

3. The method of claim 1, wherein the controlling comprises activating the desk band object.

4. The method of claim 2, wherein the loading function is selected from the group consisting of: SHLoadInProc( ), SetWindowsHookEx( ) and CreateRemoteThread( ).

5. The method of claim 1, wherein the second pointer is returned by:
obtaining an IUnknown interface pointer of the desk band object using a class identifier of the desk band object; and
obtaining the second pointer using the IUnknown interface pointer.

6. The method of claim 1, wherein the first interface to the first method is provided by:
obtaining an IUnknown interface pointer of the second object; and
obtaining a pointer to the first interface by querying the IUnknown interface of the second object.

7. A method of activating a desk band in a graphical user interface environment in a computing system having an operating system and a shell associated with the operating system, the method comprising:
loading a program code for instantiating a first object configured to activate a desk band;
instantiating the first object, wherein a constructor of the first object is executed within the shell's context;
instantiating a desk band, using the constructor, if a desk band instance does not exist within context of the shell;
instantiating a second object using the constructor, wherein the second object has a first interface to a first method configured for activating the desk band;
obtaining a desk band interface pointer associated with the desk band running in the context of the shell; and
passing the desk band interface pointer to the first method.

8. The method of claim 7, wherein the first method uses the desk band interface pointer to activate the desk band.

9. The method of claim 7, wherein the desk band interface pointer is an IUnknown interface pointer of the desk band.

10. The method of claim 7, wherein the first interface to the first method is obtained by obtaining an IUnknown interface pointer of the second object using a class identifier of the second object; and querying the IUnknown interface of the second object to obtain a pointer to the first interface.

11. The method of claim 7, wherein the loading is performed by way of an external program calling SHLoadInProc application program interface (API) and passing to it an identifier associated with the first object.

12. The method of claim 7, wherein the constructor instantiates the second object as an instance of a TrayBandSiteService class.

13. The method of claim 12, wherein the TrayBandSiteService provides a pointer to the first interface.

14. A computer readable code having computer executable instructions for installing a desk band in a computing system having an operating system and a shell with a graphical user interface (GUI), wherein the computer readable code is external to the shell, the computer readable code comprising:
logic code for loading a program code for instantiating a first object configured to activate a desk band;
logic code for instantiating the first object;
logic code for instantiating a desk band, if a desk band instance does not exist within context of the shell;
logic code for instantiating a second object, wherein the second object has a first interface to a first method configured for activating the desk band;
logic code for obtaining a desk band interface pointer associated with the desk band running in the context of the shell; and
logic code for passing the desk band interface pointer to the first method.

15. The computer readable code of claim 14, wherein the first method uses the desk band identifier to activate the desk band.

16. The computer readable code of claim 14, wherein the desk band interface pointer is the IUnknown interface pointer to the desk band.

17. The computer readable code of claim 14, wherein the first interface to the first method is obtained by obtaining an IUnknown interface pointer of the second object using a class identifier of the second object; and querying the IUnknown interface of the second object to obtain a pointer to the first interface.

18. The computer readable code of claim 14, wherein the loading is performed by way of an external program calling SHLoadInProc application program interface (API) and passing to it an identifier associated with the first object.

19. The computer readable code of claim 14, wherein a constructor of the first object instantiates the second object as an instance of a TrayBandSiteService class.

20. The computer readable code of claim 19, wherein the TrayBandSiteService provides a pointer to the first interface.
